(19) United States
(12) Patent Application Publication
(10) Pub. No.: US 2026/0292537 A1
(43) Pub. Date: Sep. 24, 2026

(54) Training or Controlling Agents to Generate Efficient Communications

(71) Applicant: GDM Holding LLC, Mountain View, CA (US)

(72) Inventors: Florian Nils Hartmann, Zurich (CH); Victor Carbune, Zurich (CH)

(21) Appl. No.: 19/086,751

(22) Filed: Mar. 21, 2025

(51) Int. Cl. H04W 24/02; G06F 40/284; H04W 24/06

(52) U.S. Cl. CPC H04W 24/02; G06F 40/284; H04W 24/06

(57) ABSTRACT

Systems and methods for generating efficient communications can include determining, based on interaction data between a first agent and a second agent, an optimization suggestion, wherein the optimization suggestion is indicative of a proposal to modify a first sequence of tokens contained in the interaction data to adhere to the optimization suggestion. The systems and methods can include processing the optimization suggestion to determine whether to accept the proposal, wherein accepting the proposal includes implementing the optimization suggestion in a message between the first agent and the second agent. The systems and methods can include, based on accepting the proposal, generating a second sequence of tokens that adheres to the optimization suggestion in the message between the first agent and the second agent.

### FIELD

The present disclosure relates generally to training or controlling an artificial intelligence agent to optimize communications. More particularly, the present disclosure relates to training or controlling machine-learned models to generate suggestions to optimize data exchanged with another machine-learned model.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include determining, based on interaction data between a first agent and a second agent, an optimization suggestion, wherein the optimization suggestion is indicative of a proposal to modify a sequence of tokens contained in the interaction data. The method can include processing the optimization suggestion to determine whether to accept the proposal, wherein accepting the proposal includes implementing the optimization suggestion in an interaction between the first agent and the second agent. The method can include, based on accepting the proposal, modifying the sequence of tokens in the interaction between the first agent and the second agent.

In some implementations, determining the optimization suggestion can include determining one or more dispensable tokens of the sequence of tokens contained in the interaction data, the dispensable tokens associated with tokens which communicate unnecessary information. In some implementations, determining the optimization suggestion can include, based on the one or more dispensable tokens, determining the optimization suggestion to remove the dispensable tokens from the interaction between the first agent and the second agent.

In some implementations, determining the optimization suggestion can include detecting one or more follow-up interactions within the interaction data, the one or more follow-up interactions associated with additional sequences of tokens communicated between the first agent and the second agent to clarify or obtain additional information. In some implementations, determining the optimization suggestion can include based on the one or more follow-up interactions, determining the optimization suggestion to add or modify tokens to the interaction between the first agent and the second agent.

In some implementations, processing the optimization suggestion includes simulating the interaction data using the optimization suggestion to generate simulated interaction data. In some implementations, processing the optimization suggestion includes comparing the interaction data and the simulated interaction data.

In some implementations, processing the optimization suggestion can include modifying, based on the optimization suggestion, a prompt associated with the interaction between the first agent and the second agent.

In some implementations, the method can include providing, based on the optimization suggestion, one or more feedback signals indicative of an efficiency outcome of the optimization suggestion.

In some implementations, the method can include training the first agent or the second agent to generate optimization suggestions.

In some implementations, the method can include training, based on the optimization suggestion, the first agent or the second agent to generate concise communications, wherein the concise communications include a minimum number of tokens.

In some implementations, the first agent and the second agent are multi-modal artificial intelligence agents.

In some implementations, the interaction data includes one or more prompts communicated between the first agent and the second agent and wherein the one or more prompts include a body of text data.

In some implementations, the proposal to modify of the first sequence of tokens contained in the interaction data can include at least one of (i) a removal of one or more tokens, (ii) an addition of one or more tokens, (iii) or a replacement of one or more tokens.

In some implementations, the method can include transmitting, by the first agent, a first prompt to the second agent. In some implementations, the method can include receiving, by the second agent, the first prompt wherein the second agent processes the first prompt to generate, in response to the first prompt, a second prompt.

In some implementations, the method can include generating, by the second agent and based on the first prompt or the second prompt, the optimization suggestion for the first agent. In some implementations, the method can include transmitting, by the second agent, the optimization suggestion to the first agent. In some implementations, the method can include receiving, by the second agent, an optimization response, wherein the optimization response is indicative of at least one of (i) an acceptance of the optimization suggestion or (ii) a rejection of the optimization suggestion.

In some implementations, the method can include, based on the optimization response indicating (i) the acceptance of the optimization suggestion, modifying, by the second agent, the second prompt or subsequent prompts to the first agent.

In some implementations, the method can include determining, by the second agent, an internal modification, wherein the internal modification includes a unilateral change to modify the interaction with the first agent.

Another example aspect of the present disclosure is directed to a computing system. The system can include one or more processors and one or more non-transitory computer-readable media storing instructions that, when implemented, cause the computing system to perform operations. The operations can include determining, based on interaction data between a first agent and a second agent, an optimization suggestion, wherein the optimization suggestion is indicative of a proposal to modify a first sequence of tokens contained in the interaction data to adhere to the optimization suggestion. The operations can include processing the optimization suggestion to determine whether to accept the proposal, wherein accepting the proposal includes implementing the optimization suggestion in a message between the first agent and the second agent. The operations can include, based on accepting the proposal, generating a second sequence of tokens that adheres to the optimization suggestion in the message between the first agent and the second agent.

In some implementations, the operation determining the optimization suggestion can include determining one or more dispensable tokens of the first sequence of tokens contained in the interaction data, the dispensable tokens associated with tokens which communicate unnecessary information. In some implementations, the operation determining the optimization suggestion can include, based on the one or more dispensable tokens, determining the optimization suggestion to remove the dispensable tokens from the message between the first agent and the second agent.

In some implementations, the operation determining the optimization suggestion can include detecting one or more follow-up interactions within the interaction data, the one or more follow-up interactions associated with additional sequences of tokens contained in the interaction data that are communicated between the first agent and the second agent to clarify or obtain additional information. In some implementations, the operation determining the optimization suggestion can include, based on the one or more follow-up interactions, determining the optimization suggestion to add or modify tokens to the message between the first agent and the second agent.

In some implementations, the operation processing the optimization suggestion to determine whether to accept the proposal can include simulating the interaction data using the optimization suggestion to generate simulated interaction data. In some implementations, the operation processing the optimization suggestion to determine whether to accept the proposal can include comparing the interaction data and the simulated interaction data.

Another example aspect of the present disclosure is directed to one or more non-transitory, computer-readable media storing instructions that, when implemented, cause one or more processors to perform operations. The operations can include determining, based on interaction data between a first agent and a second agent, an optimization suggestion, wherein the optimization suggestion is indicative of a proposal to modify a first sequence of tokens contained in the interaction data to adhere to the optimization suggestion. The operations can include processing the optimization suggestion to determine whether to accept the proposal, wherein accepting the proposal includes implementing the optimization suggestion in a message between the first agent and the second agent. The operations can include, based on accepting the proposal, generating a second sequence of tokens that adheres to the optimization suggestion in the message between the first agent and the second agent.

Other example aspects of the present disclosure are directed to other systems, methods, apparatuses, tangible non-transitory computer-readable media, and devices for performing functions described herein.

These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

For instance, aspects of the present disclosure can provide for a number of technical effects and benefits such as reducing the computational resources of machine-learned models, improving the information quality available to users, and efficiently decoding diverse outputs of machine-learned models in a single call as further described herein.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a block diagram of an example computing system according to example embodiments of the present disclosure;

FIG. 3 depicts a block diagram of an example computing system according to example embodiments of the present disclosure;

FIG. 4 depicts a dataflow pipeline according to example embodiments of the present disclosure;

FIG. 5 depicts a flow chart diagram of an example method to generate efficient communications according to example embodiments of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

Reference numerals that are repeated across plural figures are intended to identify the same features in various implementations.

### DETAILED DESCRIPTION

Generally, the present disclosure is directed to systems and methods for improved communication between artificial intelligence agents that leverage machine-learned models. More particularly, one challenge existing in the field of machine learning is that artificial intelligence agents (e.g., multi-modal agents) which are powered by or otherwise leverage machine-learned models will often communicate with each other (e.g., in natural language dialog format) to complete tasks with less than optimal efficiency (e.g., less than the minimum number of tokens and/or dialog “turns” than is strictly necessary to complete the task).

For example, a first agent may communicate with a second agent, which may be a specialized agent or an agent with access to different information to complete a task for a user. The first agent and the second agent may exchange a series of communications (e.g., structured as “turns” in a dialog) until the first agent obtains the desired information or otherwise completes an assigned task.

However, these communications may include inefficiencies that unnecessarily increase consumption of computing resources. For instance, the first agent and the second agent may generate communication outputs (e.g., prompts), transmit the communication outputs to each other, and process the communication outputs to generate responses in similar manner to prompts submitted by a human user. These communication outputs may include more tokens (e.g., which may correspond to certain words or word pieces) than strictly necessary to communicate information, may include insufficient tokens which cause follow up communications from the receiving agent, and/or may use terms or vernacular which exceeds the scope of training for a receiving agent. Thus, a technical problem in the field of machine learning is how to train machine learning models to generate efficient communications (e.g., multi-agent dialog or other communications) that preserve (e.g., minimize usage of) computing resources while arriving at the same result.

In view of the above challenge, the systems and methods described herein can provide for improved generation of efficient communications by providing optimization suggestions during a discussion, dialog, or other communication session, between multiple agents. Optimization suggestions may include suggestions to remove unnecessary tokens, add additional tokens, or use different tokens to communicate. In an implementation, the optimization suggestions may be at a message level rather than a token level. For instance, an optimization suggestion may include a suggestion to propose an entirely new message from a message which was previously communicated. In an embodiment, agents may be trained to generate and/or receive optimization suggestions in real-time and/or after a conversation has ended.

In some implementations, the agents can be or can implement a multi-modal agent (e.g., a multi-modal artificial intelligence agent). For instance, a multi-modal agent can process inputs from one or more data modalities. In some implementations, the agent can be implemented as a “situated agent”. The term situated agent refers to a setting in which the agent system shares one or more perceptual inputs with a human user. For example, the situated agent can receive and process various data inputs, including video, audio, and/or textual data which are also observable by the human user. The agent system can process these inputs to generate responses that are contextually-relevant for the user’s physical or digital environment, for example enabling the agent system to generate dialogue or other responses or outputs which assist the user in understanding and/or navigating the environment.

For example, in some implementations, a first agent and a second agent may exchange initial messages such as an initial user instruction, task specific data, user-specific data, etc., to define the scope of the conversation. The first agent and the second agent may be a machine-learned sequence processing model. For instance, the initial messages may be processed by the agents to generate one or more output responses. The output responses may include a sequence of tokens that are sampled from a corpus of tokens to construct natural language responses that are communicated between the agents. In an embodiment, interactions (e.g., interaction data) between the agents may be analyzed to detect inefficiencies in the communications. For instance, at any point during the conversation, one agent may elect to send a special message (e.g., optimization suggestion) to the other agent indicating a proposal for communication efficiency improvement.

By way of example, one of the agents may implement a chain-of-thought technique to reflect on the interaction data to identify individual tokens or messages which could have been more optimal. A chain-of thought reflection may include a technique where an agent simulates a reasoning process to determine whether a different (e.g. more efficient) message or sequence of tokens could have been used during the conversation. An output of the chain-of-thought reflection may be a determination that one or more messages or tokens included in the interaction data could have been optimized. In an embodiment, the chain-of-thought reflection may occur in-real time as the conversation between the agents is active. In another embodiment, chain-of-thought reflection may occur after the conversation has ended in an offline training phase.

Once an optimization suggestion has been generated, the agent may communicate a special message including the optimization suggestion to the other agent. For instance, an agent may provide a proposal to improve the communication with the other agent. The agent receiving the optimization suggestion may process the message to determine whether to accept or reject the optimization suggestion.

For example, in one example aspect, a receiving agent may analyze the interaction data by simulating the conversation and inject the optimization suggestion into the simulated conversation to determine whether the receiving agent would realize or otherwise result in optimization results. By way of example, a first agent associated with a user may communicate with a second agent associated with a travel booking system to obtain travel information for a requesting user. During the conversation, the second agent may provide an optimization suggestion to the first agent indicating that providing a travel identifier and confirmation number would be more efficient during communications. For instance, based on interaction data, the second agent may determine that the first agent provided substantial information (e.g., unhelpful sequence of tokens, etc.) which is inefficient or otherwise unhelpful in providing the travel information for the user. As such the optimization suggestion may include a suggestion to provide the user’s travel identifier and confirmation number for their trip to reduce the number of follow-up messages exchanged to arrive at the same result.

The first agent may receive the optimization suggestion, simulate the interaction data, and inject the optimization suggestion into the interaction by providing the user’s travel identifier and confirmation number. In an embodiment, the first agent may determine, based on the simulation, that providing the travel identifier and confirmation number reduces the number of messages exchanged between the first and second agent and accept the optimization suggestion. In another embodiment, the first agent may determine, based on the simulation, that providing the travel identifier and confirmation number does not reduce the number of messages or otherwise optimize the communications with the second agent and reject the optimization suggestion.

In another example, a first agent associated with an internet-of-things device (e.g., temperature/energy monitoring agent, etc.) may ascertain one or more properties of a household based on weather data etc. and predict a future state of the household. The first agent may communicate with a second agent (e.g., household control agent, multi-agent robotics, etc.) that is responsible for controlling relevant equipment to facilitate adjustments within the household based on the predicted future state.

During the conversation, the second agent may provide an optimization suggestion to the first agent indicating that providing a device identifier and a specific requests for the various adjustments associated with a predicted future state would be more efficient during communications. For instance, based on interaction data, the second agent may determine that the first agent provided inadequate information (e.g., inefficient sequence of tokens, etc.) regarding a future state of the household which causes additional processing to determine appropriate devices and translate the predicted future state to specific control commands. As such the optimization suggestion may include a suggestion to provide the device identifier and specific requests to reduce the computing resources needed to process messages with inadequate information and/or process additional follow up messages to arrive at the same result.

The first agent may receive the optimization suggestion, simulate the interaction data, and inject the optimization suggestion into the interaction by providing the device identifier and specific requests. In an embodiment, the first agent may determine, based on the simulation, that providing the device identifier and specific requests reduces computing resources (e.g., response time, etc.) or the number of messages exchanged between the first and second agent and accept the optimization suggestion. In another embodiment, the first agent may determine, based on the simulation, that providing the device identifier and specific requests does not reduce the response time or number of messages or otherwise optimize the communications with the second agent and reject the optimization suggestion.

In an embodiment, accepted optimization suggestions may be implemented in-real time during the conversation. For instance, the first agent may add suggestions to a next prompt communicated to the second agent during the conversation. In another embodiment, accepted optimization suggestions may be used to train the first agent offline to adhere to the optimization suggestion in future conversations with the second agent. For instance, the first agent may be trained offline. The first agent may generate a training sample by integrating the optimization suggestion into the interaction data and training on the interaction data.

In an embodiment, the optimization suggestions may be used to train agents for conversations with individual agents or may be used to train agents to communicate generally with other agents. For instance, an optimization suggestion may include a proposal (e.g., to provide device identifiers, travel identifiers, etc.) when requesting specific information. In an embodiment, the optimization suggestion may be used to train the agent to use identifiers when requesting specific information from any agent. In an embodiment, the optimization suggestion may be used to train the agent to use identifiers when requesting specific information from a specific agent. For instance, other agents may provide a contradicting optimization suggestion to refrain from using identifiers. In this manner, agents may be trained on optimization suggestions to optimize communications with specific agents and agents generally.

In an embodiment, an agent receiving an optimization suggestion may provide feedback to the agent which provided the optimization suggestion. For instance, during training, agents may be trained to provide reward signals back to agents that provide optimization suggestions based on whether the optimization suggestion was accepted. In an embodiment, the reward signal may consist of a linear combination of whether the providing agent succeeded with the task of generating a useful optimization suggestion, a measure of the effectiveness the optimization suggestion provided, etc. In an embodiment, the reward signals may improve training of agents. For instance, the reward signals may incentivize agents to provide optimization suggestions that are both likely to be successful and have a threshold measure of effectiveness. This may provide balance between solving tasks and generating optimization suggestions.

Although example descriptions contained herein describe the proposed techniques in the context of and/or with reference to an example setting in which two agents are communicating with each other, the proposed techniques can be equally applied in other example settings where more than two agents are in a shared communication session with each other.

Example aspects of the present disclosure provide systems and methods for improved communication from machine-learned models. For instance, the systems and methods described herein can train agents to optimize communications with other agents in real time by providing and implementing optimization suggestions, thereby reducing computational costs in-real time associated with multi-agent collaboration. For example, aspects of the present disclosure can provide an agent that can generate and receive communication improvements to optimize discussions. Furthermore, agents may be trained to generate effective or impactful optimization improvements thereby balancing the need to optimize communications with completing assigned tasks.

Example aspects of the present disclosure can provide for a number of technical effects and benefits, including improvements to computing technology. As one example, training agents to generate and process optimization suggestions can improve training for machine-learned models. For instance, the agent can readily generate training samples based on optimization suggestions presented by other agents observing the conversation. This provides an alternative perspective to each of the models in real-time and offline during training. In this manner, agents in a multi-agent system may generate increasingly accurate training samples to assist in training each other to optimize communication. Moreover, the agent may be trained to optimize communications in real-time providing immediate feedback and efficiency improvements.

As another example, training agents to improve communication efficiencies can improve user experience by decreasing the time for providing responses to a user. For instance, agents may spend less time communicating with each other to complete a task and provide faster responses to users, thereby providing a reduction in computing resources needed to receive, generate, render, and/or display responses via a user interface. In applications with limited network connection, such as, for example, in high network traffic areas, these time and computational savings can significantly improve usability and user experience of the systems and methods according to the present disclosure. Moreover, bandwidth may also result. For instance, optimization suggestions which cause agents to avoid sending large files or verbose messages may result in bandwidth efficiency improvements alleviating the need to transmit such large files or messages over a network.

According to example aspects of the present disclosure, by providing optimization suggestions back into the agents in real-time, the computing system can be enabled to more efficiently decode outputs during conversations, rather than waiting until the conversation is over to incorporate improvements. The aforementioned example aspects of the present disclosure therefore provide that a computing device can be enabled to alter or bias decoding of sequences of tokens in response to receiving or detecting opportunities to optimize a discussion. This can conserve significant otherwise wasted computing resources in real-time associated with decoding unhelpful or inefficient responses that fail to assist agents in completing an assigned task.

With reference now to the Figures, example embodiments of the present disclosure will be discussed in further detail.

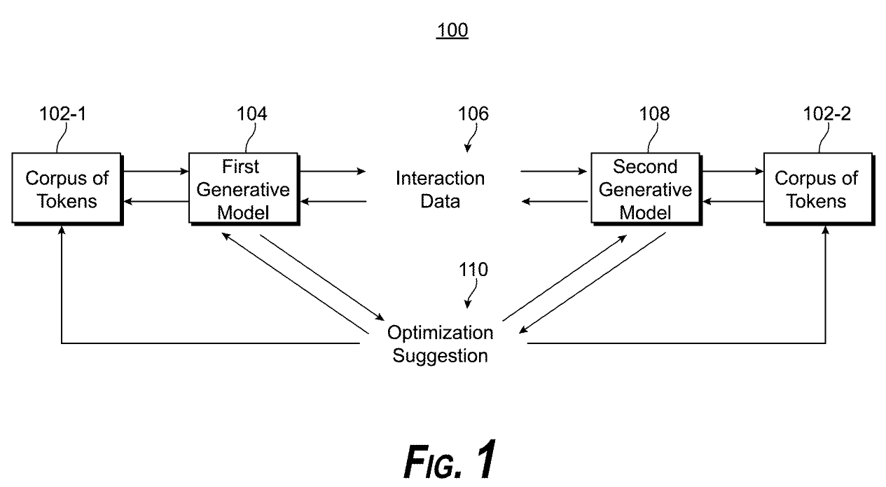

FIG. 1 depicts a block diagram of an example computing system 100 according to example embodiments of the present disclosure. In some implementations, the computing system 100 is configured to facilitate communications (e.g., interaction data 106) between a first generative model 104 and a second generative model 108, and in response to the interaction data 106 determine optimization suggestions 110 for improving or otherwise increasing the efficiency of the interaction data 106 (e.g., communications) that are subsequently or concurrently generated. The optimization suggestions 110 may increase the efficiency of the communications by reducing a number of tokens sampled from the corpuses of tokens 102-1, 102-2 compared to the number of tokens which are included in the interaction data 106.

In particular, the first generative model 104 and the second generative model 108 can generate interaction data 106 by exchanging messages (e.g., prompts, natural language texts, etc.) to complete an assigned task. The interaction data 106 can include one or more tokens or sequences of tokens sampled by the first generative model 104 or second generative model 108 from corpuses of tokens 102-1, 102-2 available to the first generative model 104 and the second generative model 108. The corpuses of tokens 102-1, 102-2 may include a collection of tokens used to train the first generative model 104 and the second generative model 108 respectively. A token can be a portion of a larger response or answer produced by the first generative model 104 or the second generative model 108. For instance, in some example implementations, the generative models (e.g., first generative model 104, second generative model 208, etc.) can generate a prompt or response prompt, such as a block of text or passage of text, comprising a plurality of tokens. The token can be any suitable token, such as, for example, a text token including text data, such as a word, phrase, sentence, letter, or other suitable delineation of text.

The first generative model 104 and the second generative model 108 can be any suitable model. For example, in some implementations, the first generative model 104 and the second generative model 108 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner.

In an embodiment, the computing system 100 may be an agent system. An agent system (e.g., an “artificial intelligence agent” or “AI agent”) can employ one or more machine-learned models (e.g., generative models, etc.) to generate outputs responsive to queries from users. As one example, an agent system can be or can include a computing system including one or more machine-learned token generation models, where the computing system is configured to receive an input from a user device or calling device and provide an output including a plurality of tokens that are responsive to the input to the user device or calling device. As one example, the plurality of tokens can be or can include text data such as words, and/or the plurality of tokens can collectively form a passage or block of text that is displayed to the user. The plurality of tokens can, for instance, collectively describe an answer or response to the user’s input.

Furthermore, in some implementations, the plurality of tokens can be or can include (e.g. or can be converted to) spoken language data such as audio data that can be spoken to the user. In some implementations, the generative models can output values, such as confidence scores or certainty scores, tonality scores, and/or other suitable scores and/or values, which are respectively associated with the plurality of tokens.

In some implementations, the agent system can be or can implement a multi-modal agent (e.g., a multi-modal artificial intelligence agent). For instance, a multi-modal agent can process inputs from one or more data modalities. In some implementations, the agent system can be implemented as a “situated agent”. For example, the first generative model 104 or the second generative model 108 may be “situated agents” which generate interaction data 106 by communicating amongst other agents to generate a response to queries from users.

In an embodiment, the interaction data 106 may include a sequential log of natural language messages (e.g., conversation transcript) exchanged between the first generative model 104 and the second generative model 108. For example, the first generative model 104 and the second generative model 108 may communicate in natural language rather than exchanging tokens or token sequences. For instance, the first generative model 104 and the second generative model 108 may communicate natural language prompts similar to prompts received from users and process the natural language prompts to generate a response. To do so, the first generative model 104 and the second generative model 108 may sample from the corpuses of tokens 102-1, 102-2 to generate a prompt or response.

By way of example, the first generative model 104 may be a “situated agent” and receive a user prompt from a user requesting lodging accommodations for an upcoming trip. In response to the user prompt, the first generative model 104 may generate a first prompt including a question or request for available lodging accommodations by sampling the corpus of tokens 102-1. In an embodiment, the first prompt may be decoded into natural language such that the first prompt includes a body of text. The first prompt may be transmitted to the second generative model 108. For example, the second generative model 108 may be an agent associated with a travel accommodations system or have access to travel accommodation data which may be inaccessible or otherwise unavailable to the first generative model 104.

The second generative model 108 may receive the first prompt and generate, in response to the first prompt, a second prompt by sampling the corpus of tokens 102-2. In an embodiment, the second prompt may be decoded into natural language such that the second prompt includes a body of text. For instance, the second prompt may include a response to the first prompt such as a request for additional information (e.g., specific locations, dates, number of guests, preferences, etc.) to complete the assigned task of retrieving lodging accommodations. In this manner, the interaction data 106 may include a sequential log of natural language messages (e.g. conversation transcript) exchanged between the first generative model 104 and the second generative model 108.

Based on the interaction data 106, the first generative model 104 and/or the second generative model 108 may determine optimization suggestions 110 to improve the efficiency of the communications between the first generative model 104 and the second generative model 108. The optimization suggestions 110 may include a proposal to a receiving generative model to modify a current or subsequent prompt (e.g., sequence of tokens, tokens, etc.). Optimization suggestions 110 may be determined at any point during an interaction between the first generative model 104 and the second generative model 108. For instance, the optimization suggestion 110 may include a proposal to remove unnecessary (e.g., dispensable) tokens from a prompt, include additional tokens (e.g., added context, etc.), or include different tokens (e.g., specific identifiers, etc.). In this manner, the optimization suggestions 110 may cause the first generative model 104 and the second generative model 108 to generate concise communications. Concise communications may include interaction data 106 that includes the minimum number of tokens (e.g., or sequences of token) to accomplish an assigned task.

The first generative model 104 and/or the second generative model 108 may analyze the interaction data 106 and determine one or more optimization suggestions 110 to improve the efficiency of the conversation. For instance, in response to receiving the first prompt, the second generative model 108 may determine an optimization suggestion which includes a proposal to the first generative model 104 to include additional information such as the specific locations, dates, number of guests, preferences, etc. to allow the second generative model 108 to immediately generate a response which includes the request information in the second prompt rather than generating a second prompt (e.g., follow up prompt) which requests this information.

For instance, in an embodiment, the second generative model 108 may transmit the optimization suggestion 110 to the first generative model 104 instead of generating a second prompt. In some embodiments, the second generative model 108 may include the optimization suggestion 110 within the second prompt. In this manner, the second generative model 108 may generate efficient communications in real-time. In other embodiments, the second generative model 108 may determine the optimization suggestion 110 after the interaction has ended and transmit the optimization suggestion to the first generative model 104 for consideration.

Once received, the first generative model 104 (e.g., receiving agent) may consider whether to implement or reject the optimization suggestion 110. For instance, the first generative model 104 may reason over optimization suggestion to determine whether accepting the proposal to include additional specific locations, dates, number of guests, preferences, etc. increases the efficiency of the interaction data 106. To do so, the first generative model 104 may construct a training sample which includes the optimization suggestion 110 by injecting the proposal into the interaction data 106 (e.g., conversation transcript). For instance, during offline training, the weights of the first generative model 104 may be optimized based on the constructed training sample. In this manner, the generative models may be trained offline to improve the efficiency of communications. For instance, output values, such as confidence scores or certainty scores, tonality scores, and/or other suitable scores and/or values, which are respectively associated with the plurality of tokens may be updated during training to train the generative models to implement optimization suggestions 110 in future discussions.

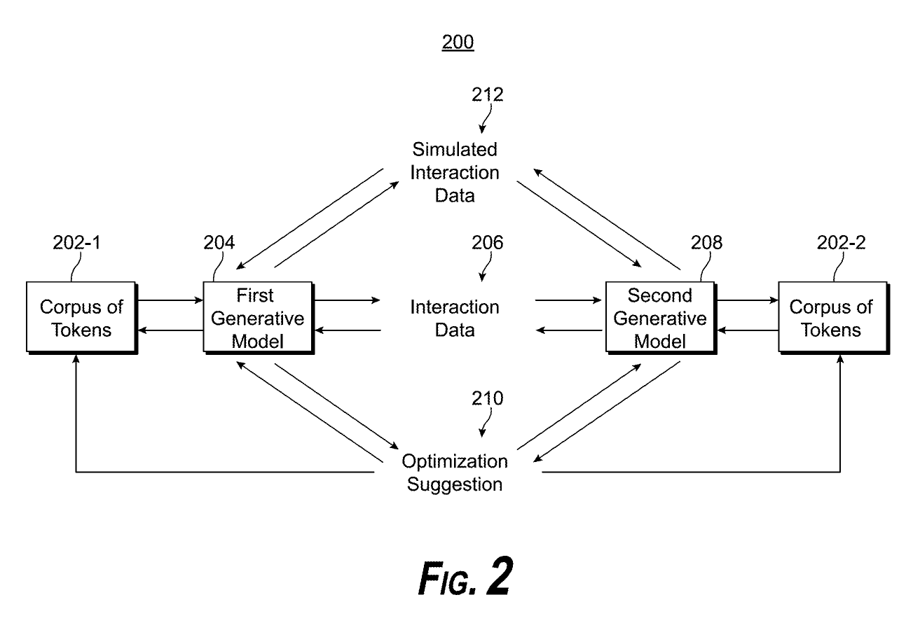

In another embodiment, the first generative model 104 may simulate the interaction data 106 and inject the optimization suggestion 110. For example, the first generative model 104 may simulate the sequential exchange of messages, inject the optimization suggestion into the conversation transcript, and simulate subsequent messages to determine whether the optimization suggestion 110 improved the efficiency of the interaction data 106. An example of simulating interaction data 106 is further described with reference to FIG. 2.

Based on determining to implement the optimization suggestion 110, the first generative model 104 may provide an optimization response indicating whether the proposal was accepted or rejected. Once the optimization response has been provided, the first generative model 104 may modify concurrent or subsequent messages. In another embodiment, the first generative model 104 may proceed with directly modifying the current or subsequent messages.

For instance, the first generative model 104 may modify a sampling (e.g., probability distributions, etc.) of tokens from the corpus of tokens 102-1 to make tokens associated with the specific locations, dates, number of guests, preferences, etc. more likely to appear in the prompt to the second generative model 108. While examples herein describe a modification sampling of tokens to include within prompts or messages, the present disclosure is not limited to such embodiment and implementation of the optimization suggestion 110 may include other communication modifications including, but not limited heuristics, rule-based communications, etc.

In an embodiment, the first generative model 104 and the second generative model 108 may accept the optimization suggestion 110 for specific or global communications. For example, the first generative model 104 may determine the optimization suggestion to lead with specific locations, dates, number of guests, preferences, etc. may be more efficient with communications with a particular generative model (e.g., agent), but may not be more efficient with other agents. For instance, other agents may prefer broader prompts to retrieve a broader dataset which may be filtered according to specific requests. In another embodiment, optimization suggestions may be globally accepted. For instance, based on optimization suggestion to provide specific information such as identifiers, dates, locations, etc., the first generative model 104 may be trained to provide this information when assigned a particular task (e.g., reservations, etc.) irrespective of the agent. In this manner, the optimization suggestions 110 may be used to train the first generative model 104 and the second generative model 108 to generate more efficient communications generally and with particular agents.

FIG. 2 depicts a block diagram of an example computing system according to example embodiments of the present disclosure. The computing system 200 is similar to the computing system 100 of FIG. 1 except that computing system 200 further includes simulated interaction data 212.

In particular, the computing system 200 can facilitate the generation of simulated interaction data 212 by the first generative model 204 and/or the second generative model 208 based on interaction data 206 or an optimization suggestion 210 determined by the first generative model 204 and/or the second generative model 208. For instance, the first generative model 204 and the second generative model 208 may analyze the interaction data 206 and determine optimization suggestions 210 to improve the efficiency of communications (e.g., interaction data 206) between the first generative model 204 and the second generative model 208. The optimization suggestions 210 can include a proposal to remove unnecessary (e.g., dispensable) tokens from a prompt, include additional tokens (e.g., added context, etc.), or include different tokens (e.g., specific identifiers, etc.). In an embodiment, the first generative model 204 and/or the second generative model 208 may generate simulated interaction data 212 to determine whether to accept an optimization suggestion 210 received from the other generative model.

For example, the optimization suggestions 210 may include a proposal which causes the receiving generative model (e.g., first generative model 204, second generative model 208, etc.) to modify tokens or sequences of tokens sampled from the corpuses of tokens 202-1, 202-2. The sampled tokens or sequences of tokens may be natural language or a body of text included in a prompt or response that is communicated between the generative models. The corpuses of tokens 202-1, 202-2 may include a collection of tokens or token sequences used to train the generative models to generate prompts, responses, etc.

In an embodiment, the generative models may determine optimization suggestions 210 by generating simulated interaction data 212 concurrently with interaction data 206. For example, at any point during the exchange of messages between the first generative model 204 and the second generative model 208, an optimization suggestion 210 may be determined by either generative model based on the interaction data 206. By way of example, the first generative model 204 may analyze the interaction data 206 (e.g., conversation transcript) and identify one or more tokens (e.g., words, phrases, etc.) which are beyond the training of the first generative model 204. For instance, the second generative model 208 may include, within one or more messages, vernacular such as acronyms or terms which the first generative model 204 has not been trained on. The use of such vernacular within the interaction data 206 may cause the first generative model 204 to respond with clarifying prompts, questions, etc. (e.g., follow up interactions).

Based on the interaction data 206 indicating the inefficiencies introduced by the second generative model’s 208 use of foreign terms or phrases, the first generative model 204 may generate simulated interaction data 212 concurrently (e.g., live during the discussion) with the interaction data 206. Simulated interaction data 212 may include a test version of the conversation transcript (e.g., interaction data 206) within a test or simulated environment such that alternative prompts or responses may be simulated within the context of the on-going discussion. For example, the first generative model 204 may generate simulated interaction data and reason over alternative tokens from the tokens contained in the interaction data 206.

By way of example, the first generative model 204 may reason over alternative tokens contained in the corpus of tokens 202-1 that are similar to tokens contained in the interaction data 206 within the context of the conversation transcript. Similar alternative tokens or token sequences may be determined by simulating candidate tokens within a threshold probability distribution, determining a distance (e.g., Levenshtein distance) between tokens, analyzing responses to follow up interactions, etc. For instance, rather than using ambiguous acronyms, the first generative model 204 may reason over the words which make up the acronym (e.g., as indicated in the interaction data 206, etc.) as an alternative for the acronym within the interaction data 206.

In an embodiment, the first generative model 204 may inject the alternative tokens (e.g., words, etc.) into the simulated interaction data 212 and simulate a response. The alternative tokens may cause the first generative model 204 to generate a different (e.g., more efficient) response to the prompt from the second generative model 208. For example, the first generative model 204 may simulate generated responses which avoid follow up interactions based on the second generative model 208 providing clear or understandable vernacular.

Based on the simulated interaction data 212, the first generative model 204 may determine an optimization suggestion 210 for the second generative model 208 to avoid the use of unclear or ambiguous vernacular such as acronyms. In an embodiment, in response to the optimization suggestion 210, the second generative model 208 may also generate simulated interaction data 212 to determine whether to accept or reject the optimization suggestion 210. For example, the second generative model 208 may receive the optimization suggestion 210 and simulate previous messages (e.g., within the interaction data 206) or subsequent (e.g., future) messages with the first generative model 204 which include the optimization suggestion.

For example, the second generative model 208 may receive the optimization suggestion 210 to refrain from using unclear vernacular such as acronyms and generate simulated interaction data 212 which includes a prompt not yet provided to the first generative model 204. For instance, the second generative model 208 may be assigned multiple tasks which have not yet been completed within the current interaction data 206. Based on the optimization suggestion 210, the second generative model 208 may simulate upcoming prompts which refrain from using acronyms and reason over likely response from the first generative model 204.

In an embodiment, the second generative model 208 may receive the optimization suggestion 210 and compute a perplexity score of received tokens. The perplexity score may indicate a measure of how many options (e.g., alternative tokens, etc.) are plausible given the context of the prompt. In an embodiment, this measure over time may provide feedback to the second generative model 208 on what exceeds the vocabulary or is out of distribution of the first generative model 204. In another embodiment, the perplexity score may also provide a mechanism to self-reflect on the ability of the second generative model model 208 to understand tokens that are received rather than sampling alternative tokens.

In an embodiment, the second generative model 208 may determine the optimization suggestion 210 improves the efficiency of the communications (e.g., interaction data 206) based on simulating less messages within the interaction data 206 to complete the assigned tasks. For example, the second generative model 208 may compare the interaction data 206 with the simulated interaction data 212 to determine whether the simulated interaction data 212 is more efficient (e.g., includes fewer tokens, messages, etc.). Based on the comparison between the interaction data 206 and the simulated interaction data 212, the second generative model 208 may also determine fewer follow up interactions when refraining from using acronyms and provide an optimization response. In this manner, the generative models may be trained in real-time to generate more efficient communications by reducing computing resources for the computing system 200.

While examples herein describe real-time generation of simulated interaction data 212, the present disclosure is not limited to such embodiment and the simulated interaction data 212 may additionally and/or alternatively be generated after the discussion between the first generative model 204 and the second generative model 208 has ended. For instance, the first generative model 204 and/or the second generative model 208 may reason over the interaction data 206 offline and generate simulated interaction data 212 to detect and determine optimization suggestions 210 for improving the efficiency of future discussions.

In an embodiment, the first generative model 204 and/or the second generative model 208 may determine an internal modification based on analyzing the interaction data 206, generating simulated interaction data 212, etc. An internal modification can include a unilateral change by the first generative model 204 and/or the second generative model 208 which modifies the current or subsequent interactions. For instance, the first generative model 204 and/or the second generative model 208 may reason over whether prompts or responses included in the interaction data 206 to determine contributions to inefficiencies. In an embodiment, the internal modifications may be the result of a self-reasoning process to cause the first generative model 204 and/or the second generative model 208 to evaluate its own performance. In some embodiments, the internal modifications may be communicated to the other generative model. In other embodiments, the internal modifications may not be communicated to the other generative model. The internal modifications may be implemented in real-time or after a conversation has ended during offline training.

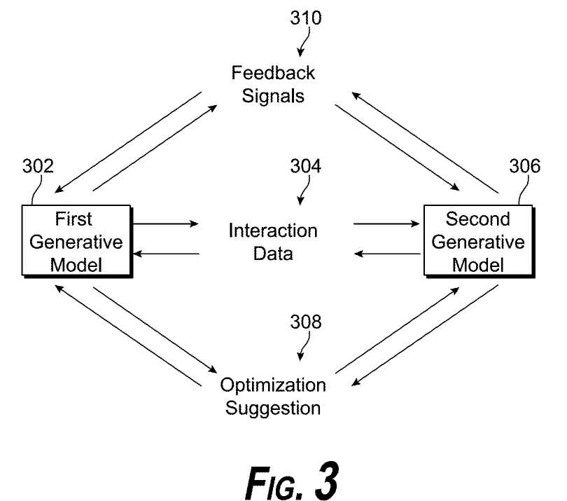

FIG. 3 depicts a block diagram of an example computing system according to example embodiments of the present disclosure. The computing system 300 is similar to the computing system 200 of FIG. 2 except that computing system 300 further includes feedback signals 310.

In particular, the computing system 300 can facilitate training of the first generative model 302 and/or the second generative model 306 using feedback signals 310. For instance, the first generative model 302 and the second generative model 306 may analyze the interaction data 304 and determine optimization suggestions 308 to improve the efficiency of communications (e.g., interaction data 304) between the first generative model 302 and the second generative model 306. The optimization suggestions 308 can include a proposal to remove unnecessary (e.g., dispensable) tokens from a prompt, include additional tokens (e.g., added context, etc.), or include different tokens (e.g., specific identifiers, etc.). In an embodiment, the first generative model 302 and/or the second generative model 306 may process a received optimization suggestion 308 to determine whether to accept or reject the proposal.

For example, the optimization suggestions 308 may include a proposal which causes the receiving generative model (e.g., first generative model 302, second generative model 306, etc.) to modify tokens or sequences of tokens that are sampled to form a response or prompt. The sampled tokens or sequences of tokens may be natural language or a body of text included in a prompt or response that is communicated between the generative models.

The first generative model 302 and/or the second generative model 306, in response to receiving an optimization suggestion 308 may determine whether to accept or reject the proposal. For example, the first generative model 302 and/or the second generative model 306 may construct training samples, generate simulated interaction data, etc. to determine whether to accept the optimization suggestion. Once the first generative model 302 and/or the second generative model 306 have determined whether to accept or reject the optimization suggestion, feedback signals may be generated to provide feedback to the generative model which generated the optimization suggestion 308.

The feedback signal 310 may include a feedback loop indicating how well the generative model performed at the task of generating the optimization suggestion 308. For instance, the feedback signals 310 may include an efficiency outcome. An efficiency outcome may include an efficiency score, metric, or other measure of efficiency gained by implementing the optimization suggestion 308. In an embodiment, the efficiency outcome may include a quantitative or qualitative measure of efficiency.

By way of example, the efficiency outcome may be a quantitative score which indicates a number of tokens removed from a conversation transcript (e.g., interaction data 304). In another embodiment, the efficiency outcome may be a qualitative measure such as a prompt or response quality measure which indicates an improvement in quality of a prompt or response. The improved quality of a prompt or response may also provide efficiency improvements resulting from faster processing of the response or prompt by the receiving generative model.

The feedback signals 310 may be provided in real-time or after a discussion has ended. Example feedback signals 310 may include, but are not limited to textual feedback communicated via a prompt, efficiency score, ground truth pairs, explicit feedback, implicit feedback, etc. The first generative model 302 and/or the second generative model 306 may receive the feedback signals 310 and adjust weights, parameters, etc. to be further trained to generate accurate optimization suggestions 308.

In an embodiment, the feedback signals 310 may encourage the first generative model 302 and/or the second generative model 306 to only generate optimization suggestions 308 which may be helpful or likely to be accepted by the other generative model. For example, generative models which generate optimization suggestions 308 which are consistently rejected may be encouraged by the feedback signals 310 to generate higher quality suggestions. In this manner, the generative models may be trained to balance the task of communicating with other generative models and the task of generating optimization suggestions 308.

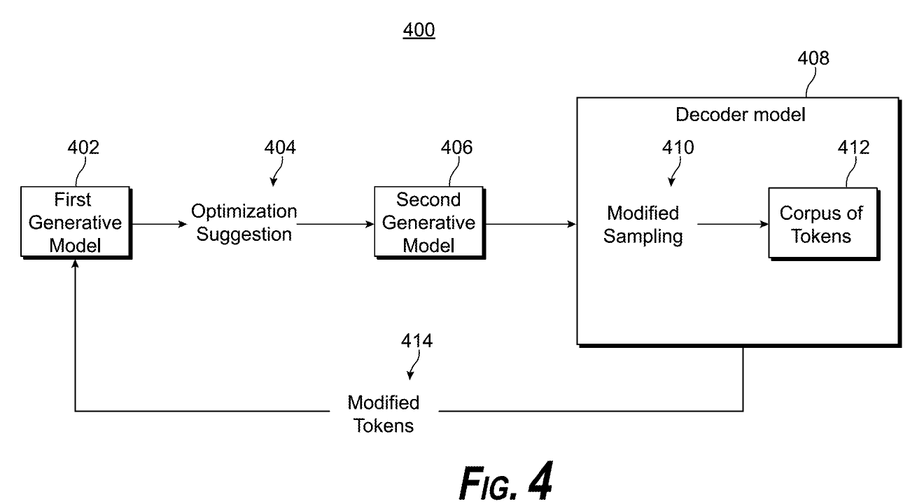

FIG. 4 depicts an example dataflow pipeline 400 according to embodiments of the present disclosure. In particular, dataflow pipeline 400 is described with an example implementation in which the a first generative model 402 determines an optimization suggestion 404 for a second generative model 406 and in response to accepting the optimization suggestions 404, the second generative model 406 may employ a modified sampling technique 410 to sample modified tokens 414 from a corpus of tokens 412. The modified tokens 414 may be included in messages (e.g., responses, prompts, etc.) within subsequent interactions with the first generative model 402 or future interactions with other models, agents, etc.

The first generative model 402 and the second generative model 406 may include can be any suitable model. For example, the first generative model 402 and the second generative model 406 can be or can include a sequence processing model. The sequence processing model can be configured to individually generate a sequence of tokens. Examples of a sequence processing model include, but are not limited to, a large language model (LLM) or a large multimodal model (LMM). For instance, the sequence processing model may generate tokens in a sequential manner.

In some implementations, the first generative model 402 may determine an optimization suggestion 404 for improving communications (e.g., interaction data) with the second generative model 406. For instance, the first generative model 402 may determine an optimization suggestion 404 indicating that prompts or responses from the second generative model 406 should remove unnecessary or redundant tokens. By way of example, the first generative model 402 may analyze interaction data (e.g., conversation transcript) of an on-going or previous interaction with the second generative model 406. Based on analyzing the interaction data, the first generative model 402 may identify one more instances where the second generative model utilized redundant language (e.g., dispensable tokens). For instance, the conversation transcript may include phrases such as “end result”, “close proximity”, “basic fundamentals”, “added bonus”, etc. The pattern of redundant phrases or dispensable tokens may cause the first generative model 402 to determine an optimization suggestion 404 for reducing the number of tokens by selecting a single word (e.g., token) for communicating information rather than using redundant phrases which require additional processing. For instance, dispensable tokens may include tokens (e.g., words) which, if removed, allow a sentence or phrase to convey the same meaning.

The second generative model 406 may receive the optimization suggestion 404 and determine to accept the optimization suggestion 404. For instance, the second generative model 406 may generate training samples, simulated interaction data, prompt injections etc., and determine that the optimization suggestion 404 will improve the efficiency of the discussion with the first generative model 402 and/or other agents. Once accepted, the optimization suggestion 404 may cause the second generative model 406 to employ a modified sampling technique 410 to remove the dispensable (e.g., redundant, unnecessary, etc.) tokens. The modified sampling technique 410 can include an updated sampling technique after the second generative model 406 has been trained.

In an embodiment, the second generative model 406 may utilize a decoder model 408 and/or any other machine-learned model to decode modified tokens 414 based on being trained using the optimization suggestion 404. The modified tokens 414 may include tokens or sequences of tokens which are different from tokens sampled prior to being trained using the optimization suggestion 404. For instance, the modified tokens 414 may remove dispensable tokens such as redundant or unnecessary tokens. While embodiments herein describe modified tokens 414 as being fewer tokens, the present disclosure is not limited to such embodiment and modified tokens 414 may additionally and/or alternatively include additional tokens or different tokens which help to reduce an overall number of messages exchanged during a conversation transcript.

The decoder model 408 be separate from, part of, or the same as the first generative model 402. The decoder model 408 may include a natural language processing model (e.g., an autoregressive language model) tuned to implement various sampling methods to decode output response. For instance, the modified sampling technique 410 resulting from the optimization suggestion 404 may employ a semantic analysis to determine semantic relationships between tokens within the corpus of tokens and exclude tokens to include in the modified tokens 414 (e.g., response, prompt, etc.) that indicate threshold level of similarity. By way of example, a token with the highest probability or likelihood of being used together within similar context may be excluded from being sampled from the corpus of tokens 412 based on the words being too similar or conveying the same meaning. Distance metrics or other techniques may be used to determine whether two tokens are similar, redundant, etc. Once the decoder model 408 has decoded a response or prompt using the modified sampling technique 410, the modified tokens 414 may be communicated to the first generative model 402 to improve the efficiency of the on-going discussion or a future discussion.

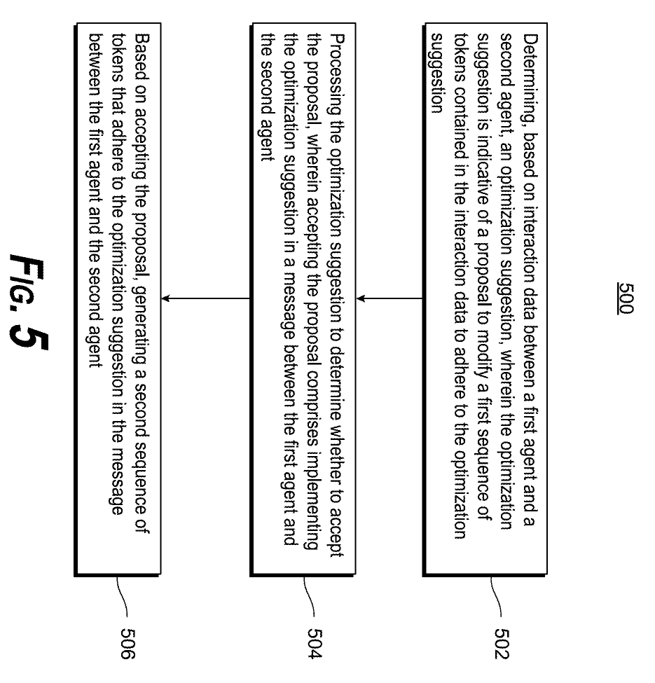

FIG. 5 depicts a flow chart diagram of an example method to generate efficient communications according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can determine, based on interaction data between a first agent and a second agent, an optimization suggestion, wherein the optimization suggestion is indicative of a proposal to modify a first sequence of tokens contained in the interaction data to adhere to the optimization suggestion. For example, a second generative model may be a “situated agent” and receive a user prompt from a user requesting directions for nearby restaurants. In response to the user prompt, the second generative model may generate a prompt including a question or request for available restaurants. In an embodiment, the prompt may be decoded into natural language such that the prompt includes a body of text. The prompt may be transmitted to a first generative model. For example, the first generative model may be an agent associated with a local business directory system or have access to restaurants data which may be inaccessible or otherwise unavailable to the second generative model.

The first generative model may receive the first prompt and generate, in response to the prompt, another prompt. In an embodiment, the other prompt may be decoded into natural language such that the other prompt includes a body of text. For instance, the other prompt may include a response to the prompt such as a request for additional information (e.g., cuisine types, time of arrival, number of guests, preferences, etc.) to complete the assigned task of retrieving restaurant options. In this manner, the interaction data may include a sequential log of natural language messages (e.g. conversation transcript) exchanged between the first agent and the second agent.

Based on the interaction data, the first generative model and/or the second generative model may determine an optimization suggestion to improve the efficiency of the communications. The optimization suggestions may include a proposal to a receiving model to modify a current or subsequent prompt (e.g., sequence of tokens, tokens, etc.). Optimization suggestions may be determined at any point during an interaction between the first generative model and the second generative model. For instance, the optimization suggestion may include a proposal to include additional tokens associated with the additional information (e.g., cuisine types, time of arrival, number of guests, preferences, etc.). In this manner, the optimization suggestions may cause the first generative model and the second generative model to generate more efficient communications across the conversation transcript by obviating the need to provide follow up messages to obtain the additional information.

At 504, the computing system can process the optimization suggestion to determine whether to accept the proposal, wherein accepting the proposal comprises implementing the optimization suggestion in a message between the first agent and the second agent. For example, once received, the first generative model and/or the second generative model (e.g., receiving agent) may consider whether to implement or reject the optimization suggestion. To do so, the receiving agent may construct a training sample based on the optimization suggestion, generate simulated interaction data, etc.

At 506, the computing system can, based on accepting the proposal, generate a second sequence of tokens that adheres to the optimization suggestion in the message between the first agent and the second agent. For example, once accepted, the optimization suggestion may cause the receiving agent to employ a modified sampling technique to include additional tokens associated with the additional information. The modified sampling technique can include an updated sampling technique once the receiving agent has been trained using the optimization suggestion.

In an embodiment, the modified sampling technique may sample tokens from a corpus of tokens which adheres to the optimization suggestion. For instance, the modified sampling technique may sample tokens or token sequences which includes the additional information to adhere to the optimization suggestion. In some embodiments, the message that adheres to the optimization suggestion may be communicated concurrently (e.g., during the live discussion) or in future discussion.

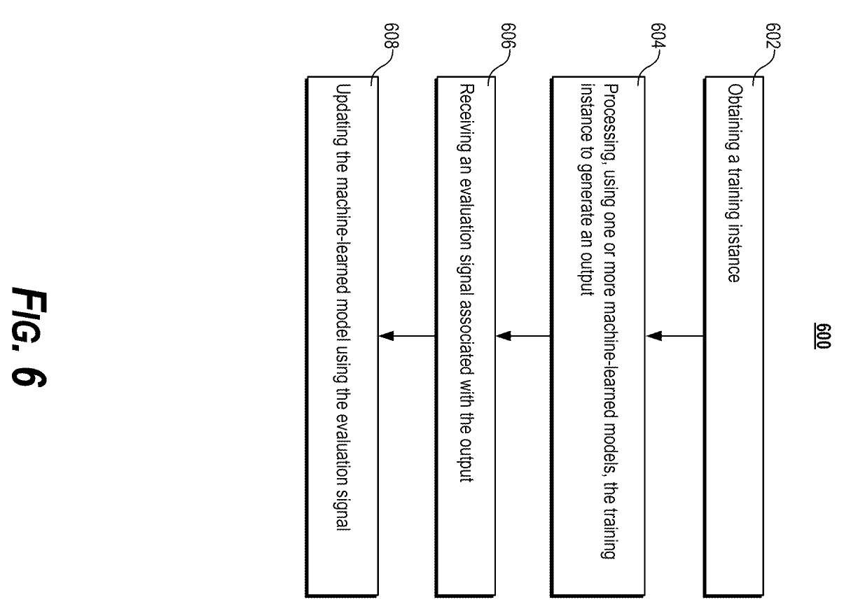

FIG. 6 depicts a flowchart of a method 600 for training one or more machine-learned models according to aspects of the present disclosure. For instance, an example machine-learned model can include a decoder model.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

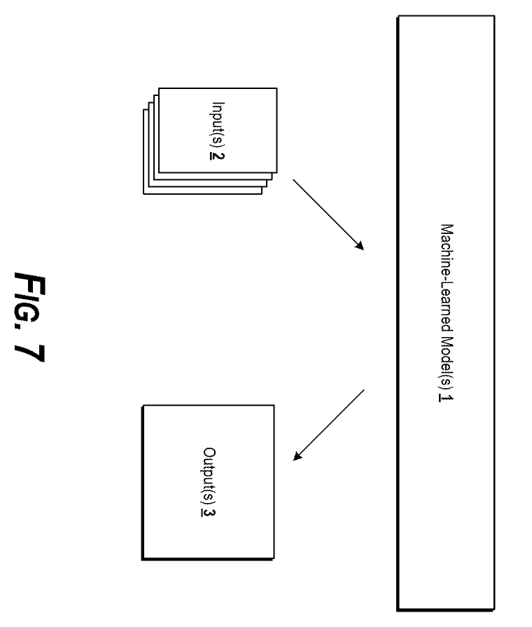

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include or otherwise be representative of any one or more of the machine-learned models described above with respect to the preceding figures. For example, machine-learned model(s) 1 can be or include, or otherwise be representative of any one or more of decoder models 408, etc. Although various features, variations, and implementations described below are described with respect to machine-learned model(s) 1, it is to be understood that such features, variations, and implementations are to be understood as described with respect to each of decoder models, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a sub the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

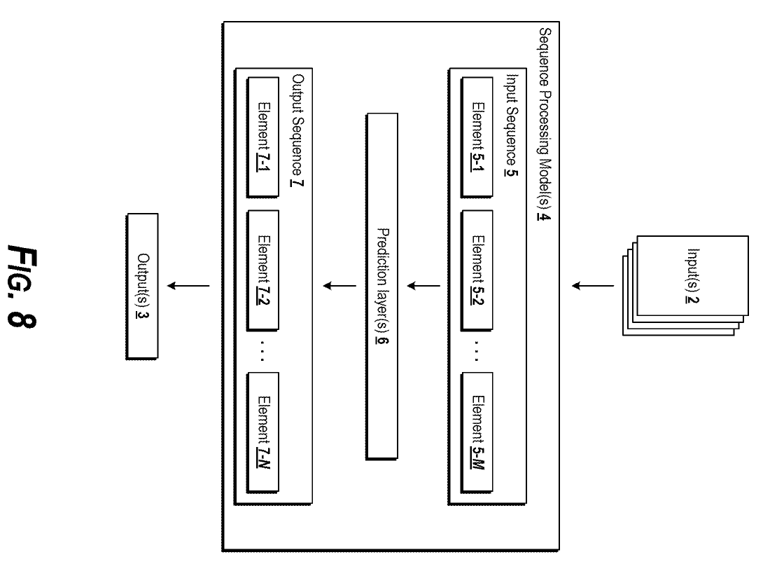

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., AudioLM: a Language Modeling Approach to Audio Generation, arXiv:2209.03143v2 (Jul. 26, 2023),

, biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a classes into which an input sequence is to be classified. For instance, a vision transformer block can pass latent state information to a multilayer perceptron that outputs a likely class value associated with an input image.

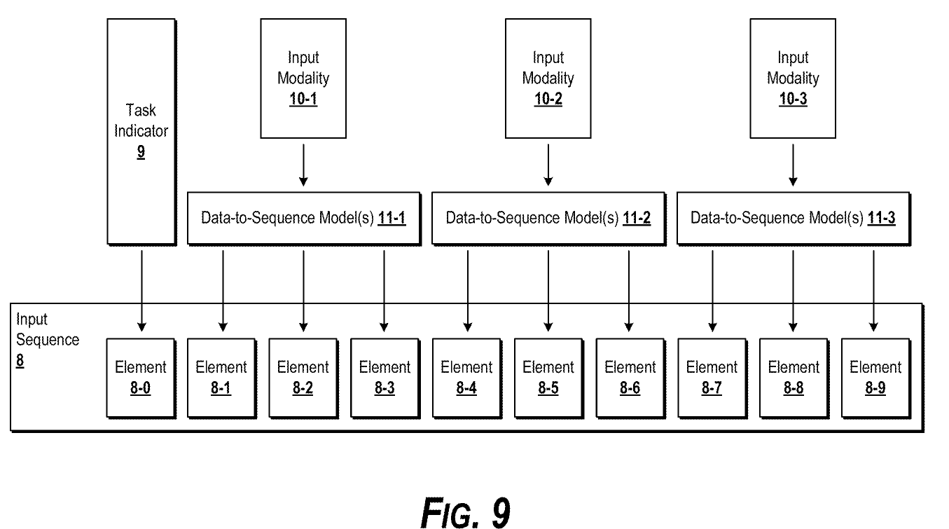

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

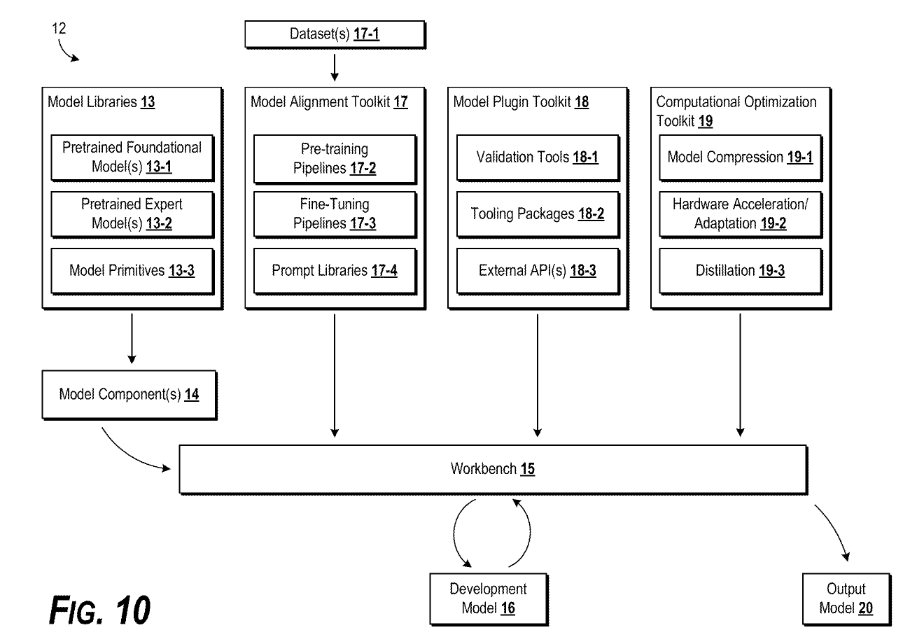

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

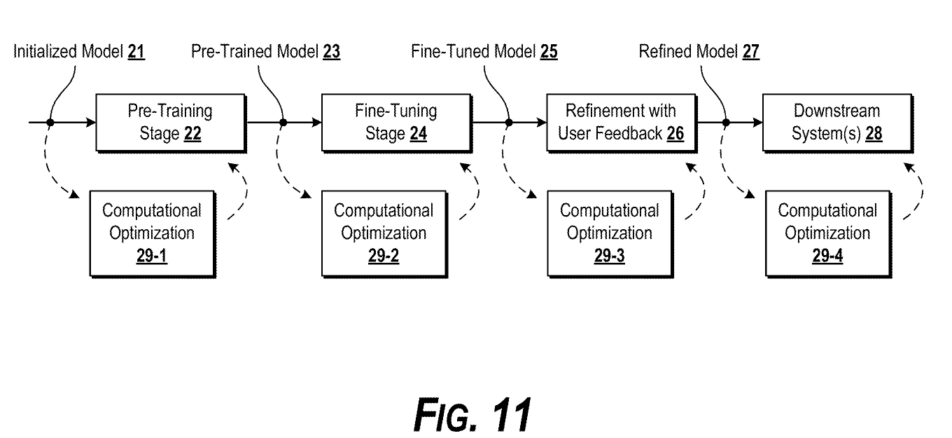

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

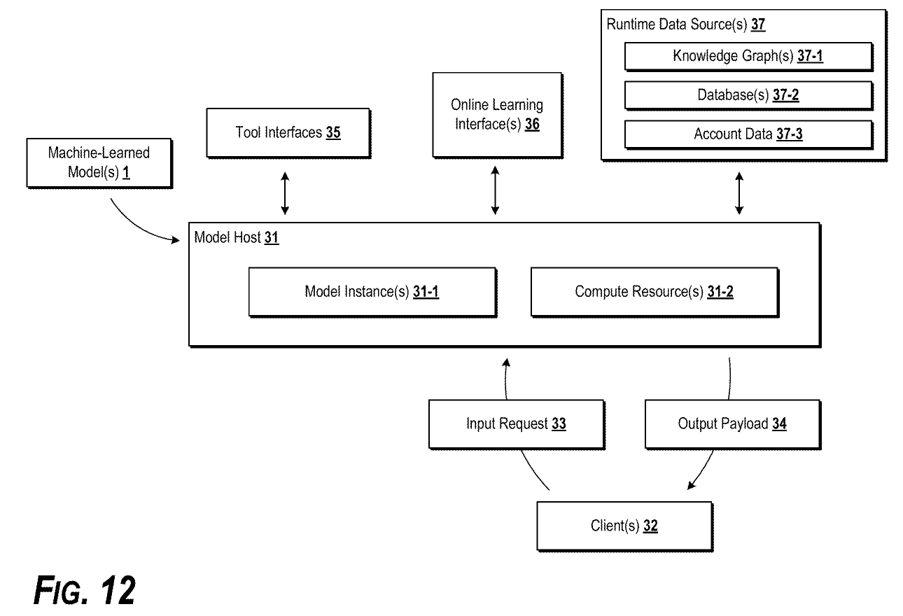

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined categories. For example, the categories can be foreground and background. As another example, the categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

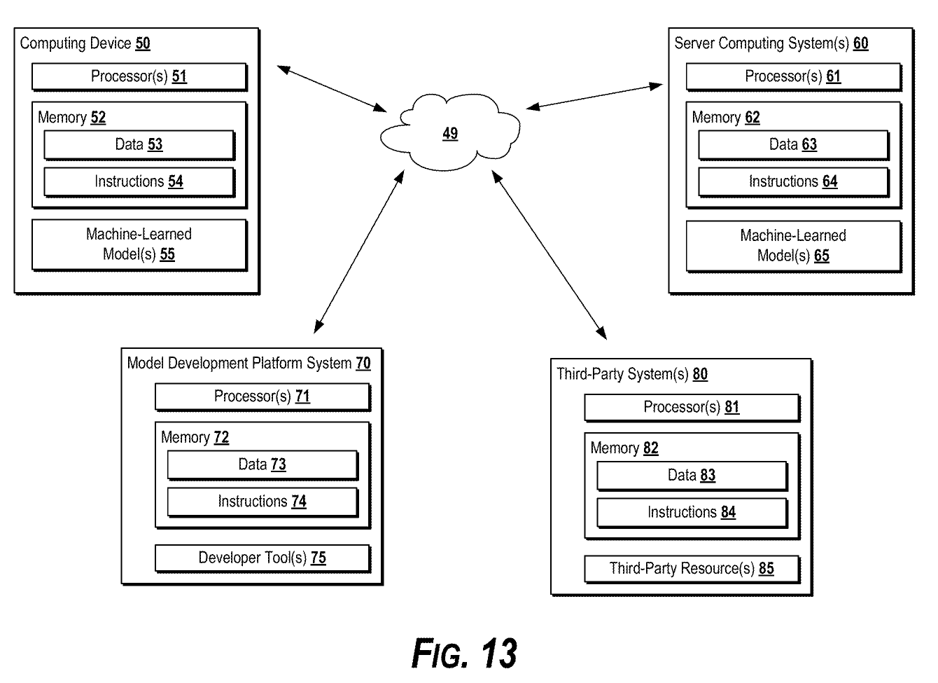

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

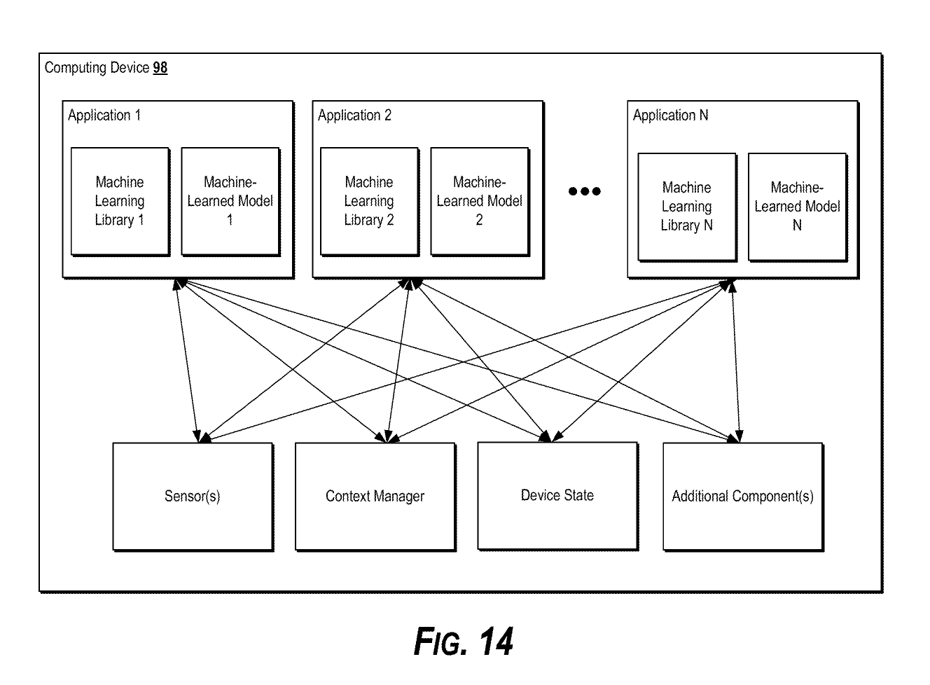

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

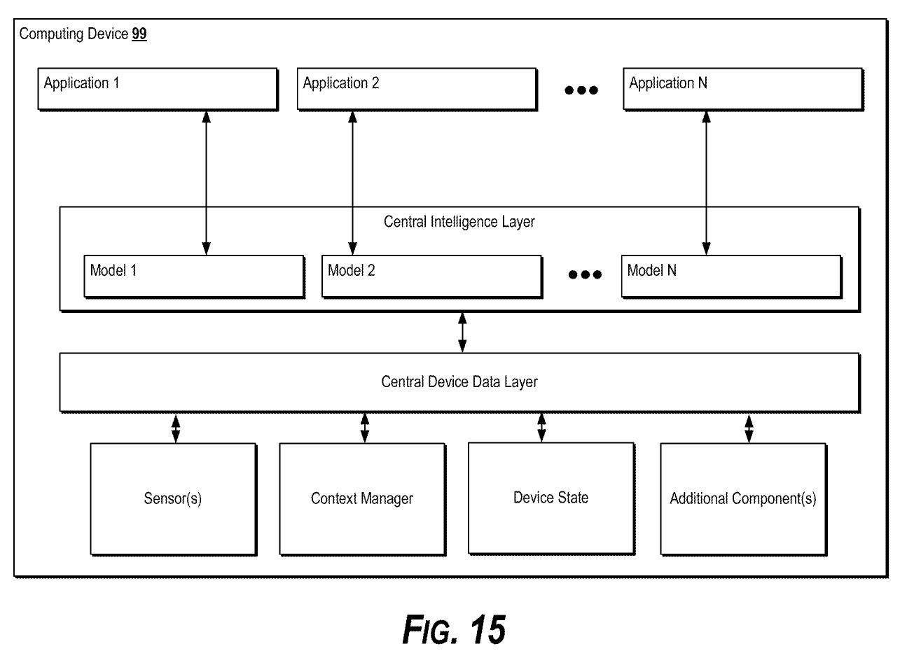

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
determining, based on interaction data between a first agent and a second agent, an optimization suggestion, wherein the optimization suggestion is indicative of a proposal to modify a first sequence of tokens contained in the interaction data to adhere to the optimization suggestion;
processing the optimization suggestion to determine whether to accept the proposal, wherein accepting the proposal comprises implementing the optimization suggestion in a message between the first agent and the second agent; and
based on accepting the proposal, generating a second sequence of tokens that adheres to the optimization suggestion in the message between the first agent and the second agent.

2. The computer-implemented method of claim 1, wherein determining the optimization suggestion comprises:
determining one or more dispensable tokens of the first sequence of tokens contained in the interaction data, the dispensable tokens associated with tokens which communicate unnecessary information; and
based on the one or more dispensable tokens, determining the optimization suggestion to remove the dispensable tokens from the message between the first agent and the second agent.

3. The computer-implemented method of claim 1, wherein determining the optimization suggestion comprises:
detecting one or more follow-up interactions within the interaction data, the one or more follow-up interactions associated with additional sequences of tokens contained in the interaction data that are communicated between the first agent and the second agent to clarify or obtain additional information; and
based on the one or more follow-up interactions, determining the optimization suggestion to add or modify tokens to the message between the first agent and the second agent.

4. The computer-implemented method of claim 1, wherein processing the optimization suggestion comprises:
simulating the interaction data using the optimization suggestion to generate simulated interaction data; and
comparing the interaction data and the simulated interaction data.

5. The computer-implemented method of claim 1, wherein processing the optimization suggestion comprises:
modifying, based on the optimization suggestion, a prompt associated with the message between the first agent and the second agent.

6. The computer-implemented method of claim 1, further comprising:
providing, based on the optimization suggestion, one or more feedback signals indicative of an efficiency outcome of the optimization suggestion.

7. The computer-implemented method of claim 1, further comprising:
training the first agent or the second agent to generate the optimization suggestion.

8. The computer-implemented method of claim 1, further comprising:
training, based on the optimization suggestion, the first agent or the second agent to generate concise communications, wherein the concise communications comprise a minimum number of tokens.

9. The computer-implemented method of claim 1, wherein the first agent and the second agent are multi-modal artificial intelligence agents.

10. The computer-implemented method of claim 1, wherein the interaction data comprises one or more prompts communicated between the first agent and the second agent and wherein the one or more prompts comprise a body of text data.

11. The computer-implemented method of claim 1, wherein the proposal to modify of the first sequence of tokens contained in the interaction data comprises at least one of (i) a removal of one or more tokens, (ii) an addition of one or more tokens, (iii) or a replacement of one or more tokens.

12. The computer-implemented method of claim 1, further comprising:
transmitting, by the first agent, a first prompt to the second agent; and
receiving, by the second agent, the first prompt wherein the second agent processes the first prompt to generate, in response to the first prompt, a second prompt.

13. The computer-implemented method of claim 12, further comprising:
generating, by the second agent and based on the first prompt or the second prompt, the optimization suggestion for the first agent;
transmitting, by the second agent, the optimization suggestion to the first agent; and
receiving, by the second agent, an optimization response, wherein the optimization response is indicative of at least one of (i) an acceptance of the optimization suggestion or (ii) a rejection of the optimization suggestion.

14. The computer-implemented method of claim 13, further comprising:
based on the optimization response indicating (i) the acceptance of the optimization suggestion, modifying, by the second agent, the second prompt or subsequent prompts to the first agent.

15. The computer-implemented method of claim 13, further comprising:
determining, by the second agent, an internal modification, wherein the internal modification comprises a unilateral change to modify the interaction with the first agent.

16. A computing system comprising:
one or more processors; and
one or more non-transitory, computer-readable media storing instructions that, when implemented, cause the one or more processors to perform operations comprising:
determining, based on interaction data between a first agent and a second agent, an optimization suggestion, wherein the optimization suggestion is indicative of a proposal to modify a first sequence of tokens contained in the interaction data to adhere to the optimization suggestion;
processing the optimization suggestion to determine whether to accept the proposal, wherein accepting the proposal comprises implementing the optimization suggestion in a message between the first agent and the second agent; and
based on accepting the proposal, generating a second sequence of tokens that adheres to the optimization suggestion in the message between the first agent and the second agent.

17. The computing system of claim 16, wherein determining the optimization suggestion comprises:
determining one or more dispensable tokens of the first sequence of tokens contained in the interaction data, the dispensable tokens associated with tokens which communicate unnecessary information; and
based on the one or more dispensable tokens, determining the optimization suggestion to remove the dispensable tokens from the message between the first agent and the second agent.

18. The computing system of claim 16, wherein determining the optimization suggestion comprises:
detecting one or more follow-up interactions within the interaction data, the one or more follow-up interactions associated with additional sequences of tokens contained in the interaction data that are communicated between the first agent and the second agent to clarify or obtain additional information; and
based on the one or more follow-up interactions, determining the optimization suggestion to add or modify tokens to the message between the first agent and the second agent.

19. The computing system of claim 16, wherein processing the optimization suggestion to determine whether to accept the proposal comprises:
simulating the interaction data using the optimization suggestion to generate simulated interaction data; and
comparing the interaction data and the simulated interaction data.

20. One or more non-transitory, computer-readable media storing instructions that, when implemented, cause one or more processors to perform operations, the operations comprising:
determining, based on interaction data between a first agent and a second agent, an optimization suggestion, wherein the optimization suggestion is indicative of a proposal to modify a first sequence of tokens contained in the interaction data to adhere to the optimization suggestion;
processing the optimization suggestion to determine whether to accept the proposal, wherein accepting the proposal comprises implementing the optimization suggestion in a message between the first agent and the second agent; and
based on accepting the proposal, generating a second sequence of tokens that adheres to the optimization suggestion in the message between the first agent and the second agent.
